(19) United States
(12) Patent Application Publication
(10) Pub. No.: US 2009/0157574 A1
(43) Pub. Date: Jun. 18, 2009

(54) METHOD AND APPARATUS FOR ANALYZING WEB SERVER LOG BY INTRUSION DETECTION SYSTEM

(76) Inventor: Sang Hun Lee, Daejeon (KR)

Correspondence Address: LADAS & PARRY LLP, 224 SOUTH MICHIGAN AVENUE, SUITE 1600, CHICAGO, IL, 60604, US

(21) Appl. No.: 12/249,083

(22) Filed: Oct. 10, 2008

(30) Foreign Application Priority Data
Dec. 17, 2007 (KR) 10-2007-0132749

(51) Int. Cl. G06F 15/18; G06N 5/02; G06F 12/14; G06F 17/30

(52) U.S. Cl. 706/12; 706/47; 726/23

(57) ABSTRACT

Provided is hacking prevention technology, and more particularly, a method and apparatus for automatically analyzing log information of a web server for which intrusion is attempted from an outside source.

In one embodiment, a method of analyzing a web server log using an intrusion detection scheme includes receiving log information of a web server from a manager; determining if there is a hacking attempt by analyzing the received log information of the web server based on a predetermined hacking attempt detection rule; and generating a checklist report based on the result of determination.

Accordingly, it is possible to enable a manager to effectively cope with an external intrusion by automatically analyzing log information of a web server intruded from an outside source and reporting the same to the manager.

### CROSS-REFERENCE TO RELATED APPLICATION

This application claims priority to and the benefit of Korean Patent Application No. 2007-132749, filed Dec. 17, 2007, the disclosure of which is incorporated herein by reference in its entirety.

### BACKGROUND

1. Field of the Invention

The present invention relates to hacking prevention technology, and more particularly, to a method and apparatus for automatically analyzing log information of a web server for which intrusion has been attempted from an outside source.

2. Discussion of Related Art

Currently, due to diffusion of high speed networks and the Internet, web servers performing services via the Internet are also rapidly developing. Companies use the web as a business tool and people use the web to search information. Companies operate their own homepage to promote the company and products, and even Internet users may operate their own homepage. Specifically, the Internet is currently becoming popularized and generalized in our day-to-day lives.

However, with the popularization and generalization of the Internet, hacking technology using vulnerability of the web server has also advanced. Specifically, since an information service server or a homepage via web has various types of vulnerability in security due to misconstruction of the web server or the homepage, mis-installation of Common Gateway Interface (CGI), and the like, hackers have recently been attacking the homepages or the information service servers.

Hereinafter, conventional schemes to prevent an attack from an outside source will be described.

A first scheme is a basic authentication scheme. The basic authentication scheme stores password information corresponding to user identification (ID) in a server in an encoded state and then encodes a password of a user attempting access to thereby allow the access depending on whether the password is the same as a stored value. The basic authentication scheme is advantageous in an aspect of simplicity, but is vulnerable to a replay attack since the user password is easily encoded and transmitted to a server. Also, managing user ID and password information can be burdensome on the server.

A second scheme is an access control scheme using a network address. The access control scheme using the network address controls an access to a server using Internet Protocol (IP) address information that is assigned to each client system. Accordingly, it is possible to readily control an access even with respect to a client set belonging to a particular domain by using structural characteristics of the network address. Also, since threats attempting an access by stealing the user ID and the password can be prevented to some extent, the access control scheme using the network address is being widely used. Moreover, the access control scheme using the network address does not expose the user ID and the password and thus may be safe. However, since most attackers can spoof their IP address, the access control scheme is vulnerable to masquerade attack.

In addition to the above schemes, there is a Message Digest Authentication scheme that applies a message digest function to user information to transmit to a server. Here, the message digest function has uni-directional characteristics.

As described above, since web generally guarantees anonymity, it is not easy to realize appropriate access control in a server and also, since a message is transmitted as a plaintext, confidentiality cannot be expected.

Accordingly, there is a need for an automatic check tool that can effectively detect a hacking attempt from an outside source to thereby prevent the hacking attempt, and also can effectively analyze a hacking incident when the hacking incident using a web server incurs. For this, there is a need for a scheme that can prevent vulnerability to hacking by specifically studying a system hacking method used by actual hackers, vulnerability of a homepage, etc., and analyzing a precise countermeasure plan.

### SUMMARY OF THE INVENTION

The present invention is directed to a method and apparatus for automatically analyzing log information of a web server for which intrusion is attempted from an outside source.

The present invention is also directed to a method and apparatus for analyzing log information of a web server and determining a hacking attempt based on the result of analysis and a predetermined rule.

The present invention is also directed to a method and apparatus for determining a hacking attempt based on a determination criterion obtained by learning.

The present invention is also directed to a method and apparatus for analyzing log information of a web server that can effectively analyze a hacking incident when the hacking incident incurs and report the same to a manager to thereby verify an accurate intrusion cause.

The additional purposes of the present invention will be understood by the following description and exemplary embodiments of the present invention.

One aspect of the present invention provides a method of analyzing a web server log using an intrusion detection scheme, including: receiving log information of a web server from a manager; determining if there is a hacking attempt by analyzing the received log information of the web server based on a predetermined hacking attempt detection rule; and generating a checklist report based on the result of determination.

Here, the method may further include: generating a learning-induced determination criterion by learning log information that has been determined as normal; and analyzing the received log information based on the leaning-induced determination criterion to determine the hacking attempt.

Another aspect of the present invention provides an apparatus for analyzing a web server log using an intrusion detection scheme, including: an input unit for receiving log information of a web server from a manager; a determination unit for determining if there is a hacking attempt by analyzing the log information of the web server based on a predetermined hacking attempt detection rule; and an output unit for generating a checklist report based on the result of determination by the determination unit.

Here, the determination unit may include an intrusion attempt determining module for generating a learning-induced determination criterion by learning log information that has been determined as normal and analyzing the received log information based on the learning-induced determination criterion to determine the hacking attempt.

### BRIEF DESCRIPTION OF THE DRAWINGS

The above and other features and advantages of the present invention will become more apparent to those of ordinary skill in the art by describing in detail preferred embodiments thereof with reference to the attached drawings in which:

FIG. 1 is a schematic diagram of a system for managing web server log information according to an embodiment of the present invention;

FIG. 2 is a conceptual diagram illustrating a basic concept for analyzing log information of a web server intruded from an outside source according to an embodiment of the present invention;

FIG. 3 is a block diagram of a log analyzing apparatus according to an embodiment of the present invention; and

FIG. 4 is a flowchart illustrating a method of analyzing log information of a web server intruded from an outside source according to an embodiment of the present invention.

### DETAILED DESCRIPTION OF EXEMPLARY EMBODIMENTS

Hereinafter, exemplary embodiments of the present invention will be described in detail. However, the present invention is not limited to the embodiments disclosed below, but can be implemented in various forms. Therefore, the following embodiments are described in order for this disclosure to be complete and enabling to those of ordinary skill in the art.

When it is determined that detailed description related to a related known function or configuration may make the purpose of the present invention unnecessarily ambiguous in describing the present invention, the detailed description will be omitted here. Also, terms used herein are defined based on the function of the present invention and thus may be changed depending on a user, the intent of an operator, or a custom. Accordingly, the terms must be defined based on the overall description of this specification.

In an embodiment of the present invention to be described later, log information of a web server intruded from an outside source is analyzed based on a predetermined hacking attempt detection rule and information obtained by learning. The determination criterion is updated based on the result of analysis to maintain latest information associated with hacking at all times.

Also, a log analyzing apparatus according to an embodiment of the present invention is constructed to operate regardless of whether the log analyzing apparatus has access to the Internet. It is assumed that web server log information is input by a manager in order to avoid load to a web server in operation.

Hereinafter, exemplary embodiments of the present invention will be described in detail with reference to the accompanying drawings.

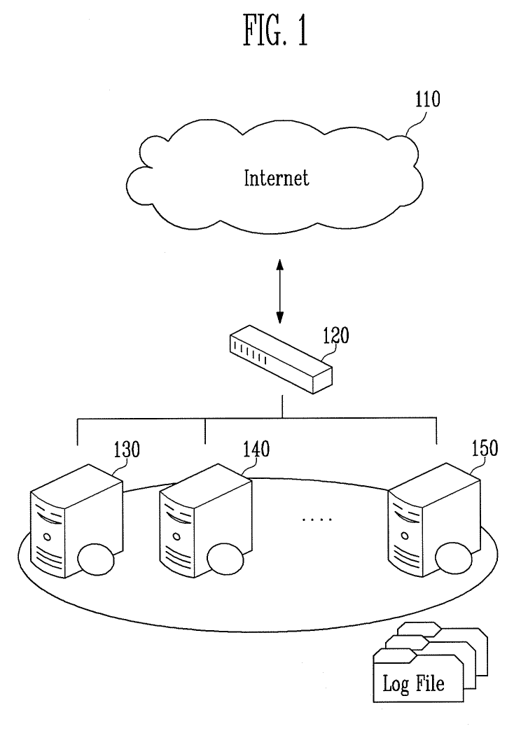

Initially, web server log information managed in a web server will be described with reference to FIG. 1. FIG. 1 is a schematic diagram of a system for managing web server log information.

Referring to FIG. 1, external users may access any desired web servers 130 through 150 via the Internet 110. The internet 110 and the web servers 130 through 150 are connected to each other via a switch 120. Although not illustrated in FIG. 1, a firewall may be provided separate from the switch 120.

The web servers 130 through 150 may include various types of servers according to a function thereof. For example, the web servers 130 through 150 may include Apache Web Server (AWS) 130, Web Application Server (WAS) 140, Internet Information Server (IIS) 150, etc. The web servers 130 through 150 manage information about an external access person as web server log information. Specifically, Internet-based web server programs include a log directory, and a file (e.g., access.log, and error.log) in which web server log information is recorded. Information about a visitor accessing the web server, an access path, a busy access time, change in the number of accesses, etc., is managed by the web server log information

When using the web server log information of the web servers 130 through 150, it is possible to know an accessed user, an accessed document, an access failure reason, etc., and thus it is possible to restore or process a security incident. Also, a company operating the web servers 130 through 150 uses analysis results of the web server log information for traffic analysis, degree of concern for an access path, i.e. referrer, and a site, content utilization, drilldown analysis of a dynamic content, analysis of advertising effect, characteristic analysis of inside member, product analysis, etc.

FIG. 2 is a conceptual diagram illustrating a basic concept for analyzing log information of a web server intruded from an outside source according to an embodiment of the present invention.

Referring to FIG. 2, a manager 210 inputs various types of information needed to determine a hacking attempt, via a manager interface 220. The information needed to determine the hacking attempt includes a predetermined hacking attempt detection rule and web server log information. The hacking attempt detection rule is reference information to determine the hacking attempt and may be obtained by analyzing an intrusion type of an intruder, an intrusion purpose, etc. Accordingly, the hacking attempt detection rule needs to be periodically updated by the manager.

As described above, the web server log information includes the person accessing the server, the accessed path, a busy access time zone, change in the number of accesses, the accessed document, the access failure reason, etc.

The hacking attempt detection rule and the web server log information that are provided from the manager 210 via the manager interface 220 are input into a log analyzing apparatus 230. The log analyzing apparatus 230 analyzes the web server log information based on the hacking attempt detection rule pre-input by the manager 210 or the learning-induced determination criterion, to thereby determine hacking attempt.

The learning-induced determination criterion may be generated through learning that uses log information determined to be normal as an input.

Also, the log analyzing apparatus 230 constructs the analysis result of the web server log information in a form of a database and stores in a storage 240. When the analyzed log information corresponds to hacking, the database stores inspection details and hacking details, and when the analyzed log information is a normal log, the database stores only the inspection contents.

The analysis result by the log analyzing apparatus 230 is reported to a manager 210 via the manager interface 220. The report may be in a form of print, display, and the like.

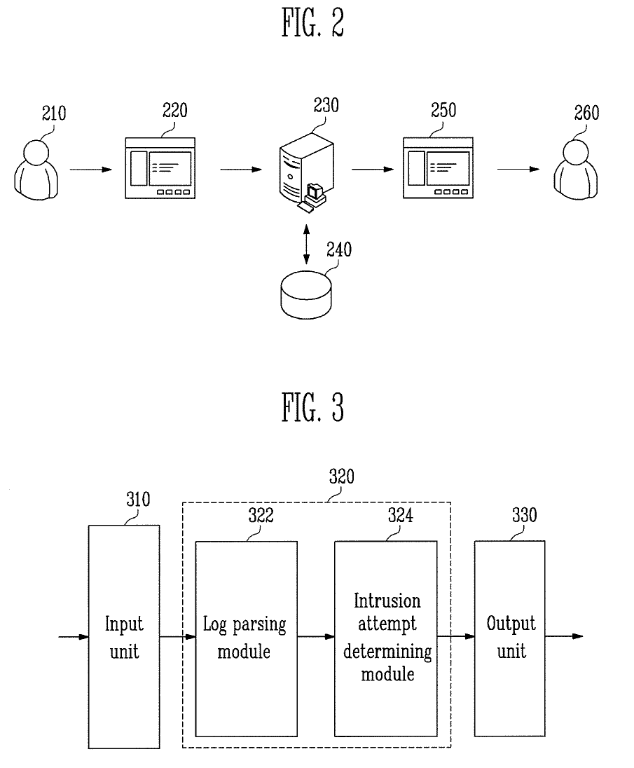

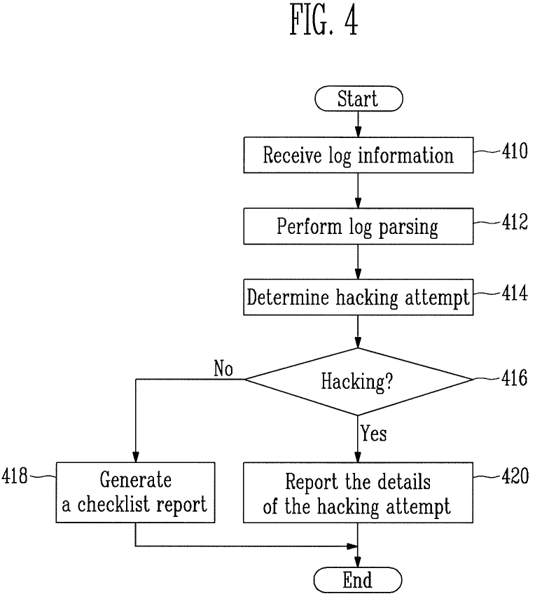

FIG. 3 is a block diagram of a log analyzing apparatus according to an embodiment of the present invention. The log analyzing apparatus 230 includes an input unit 310, a determination unit 320, and an output unit 330. The determination unit 320 includes a log parsing module 322 and an intrusion attempt determining module 324.

The log analyzing apparatus shown in FIG. 3 is installed in a physically separated location from a currently operated web server in order not to affect the web server. Also, the log analyzing apparatus functions to receive web log information from a web server manager, analyze the log information, and report the analysis result to the web server manager.

Referring to FIG. 3, the input unit 310 receives information needed to determine a hacking attempt. The information needed to determine the hacking attempt includes a predetermined hacking attempt detection rule and web server log information. The hacking attempt detection rule and the web server log information input through the input unit 310 are output to the determination unit 320.

The determination unit 320 determines the hacking attempt based on the hacking attempt detection rule pre-input by the manager or a learning-induced determination criterion.

Hereinafter, a structure and operation of the determination unit 320, which includes the log parsing module 332 and an intrusion attempt determining module 324, will be further described in detail.

The log parsing module 322 parses the input web server log to thereby generate a parsing result that can be used to determine a hacking attempt. For this, the log parsing module 322 parses the web server log information to thereby extract information that is needed to determine the hacking attempt, and rearrange the extracted information in a predetermined form, thereby generating the parsing result.

The parsing result generated by the log parsing module 322 is provided to the intrusion attempt determining module 324. The intrusion attempt determining module 324 determines the hacking attempt based on the parsing result.

In order to determine the hacking attempt, two methods are used. One is to determine based on the predetermined hacking attempt detection rule and the other is to determine based on the extraction of abnormal log by learning of a system. Also, the intrusion attempt determining module 324 sets information about the log determined to be normal as a learning input and then repeats learning to thereby update the learning-induced determination criterion with latest data.

The determination result from the log parsing module 322 is provided to the output unit 330. The output unit 330 reports the determination result of the hacking attempt to the manager via a separate medium such as a printer, a monitor, etc. Also, the output unit 330 records the determination result of the hacking attempt in a database.

FIG. 4 is a flowchart illustrating a method of analyzing log information of a web server intruded from an outside source according to an embodiment of the present invention.

Referring to FIG. 4, in step 410, log information of a web server is input by a manager. It is assumed that a hacking attempt detection rule has been input by the manager for log analysis.

In step 412, the web server log information is parsed. Specifically, the web server log information is parsed to generate a parsing result by extracting information needed to determine the hacking attempt and rearranging the extracted information in a predetermined form.

In step S414, it is determined if there is a hacking attempt based on the parsing result. Here, the log analyzing apparatus may determine the hacking attempt based on the pre-input hacking attempt detection rule and may also determine the hacking attempt by checking whether abnormal web server log information exists based on the learning-induced determination criterion.

When it is determined that there is a hacking attempt in step 416, the process proceeds to step 420 and, when it is determined as normal log, it proceeds to step 418.

In step 418, a checklist report is generated and stored in a data base. It may be also reported to the manager.

In step 420, the details of the hacking attempt is reported to the manager.

As described above, according to the present invention, it is possible to enable a manager to effectively cope with an external intrusion by automatically analyzing log information of a web server intruded from an outside source and reporting the same to the manager.

While the invention has been shown and described with reference to certain exemplary embodiments thereof, it will be understood by those skilled in the art that various changes in form and details may be made therein without departing from the spirit and scope of the invention as defined by the appended claims.

For example, in exemplary embodiments of the present invention, it is assumed that the web server log information is input by the manager, but the web server log information may be provided from a web server periodically or according to a manager's request. The hacking details may be provided to a remote manager using a communication medium.

What is claimed is:

1. A method of analyzing a web server log using an intrusion detection scheme, comprising:
receiving log information of a web server from a manager;
determining if there is a hacking attempt by analyzing the received log information of the web server based on a predetermined hacking attempt detection rule; and
generating a checklist report based on the result of determination.

2. The method of claim 1, further comprising:
generating a learning-induced determination criterion by learning log information that has been determined as normal; and
analyzing the received log information based on the learning-induced determination criterion to determine the hacking attempt.

3. The method of claim 1, wherein the determining if there is a hacking attempt comprises parsing the log information to generate a parsing result of a form that can be used to determine the hacking attempt and determining the hacking attempt based on the generated parsing result.

4. The method of claim 3, wherein the determining if there is a hacking attempt comprises parsing the log information to extract information that is needed to determine the hacking attempt and rearranging the extracted information in a predetermined form, thereby generating the parsing result.

5. The method of claim 4, wherein the information that is needed to determine the hacking attempt includes at least one of an accessing person, an accessed document, an access failure reason, and an access path.

6. The method of claim 1, further comprising, when it is determined that there is a hacking attempt, recording details of the hacking attempt in the checklist report.

7. The method of claim 6, further comprising outputting the checklist report to the manager.

8. An apparatus for analyzing a web server log using an intrusion detection scheme, comprising:
an input unit for receiving log information of a web server from a manager;
a determination unit for determining if there is a hacking attempt by analyzing the log information of the web server based on a predetermined hacking attempt detection rule; and
an output unit for generating a checklist report based on the result of determination by the determination unit.

9. The apparatus of claim 8, wherein the determination unit comprises: an intrusion attempt determining module for generating a learning-induced determination criterion by learning log information that has been determined as normal and analyzing the received log information based on the learning-induced determination criterion to determine the hacking attempt.

10. The apparatus of claim 9, wherein the determination unit comprises: a log parsing module for parsing the log information to generate a parsing result of a form that can be used to determine the hacking attempt, and
the intrusion attempt determining module determines the hacking attempt based on the generated parsing result.

11. The apparatus of claim 10, wherein the log parsing module parses the log information to extract information that is needed to determine the hacking attempt and rearrange the extracted information in a predetermined form, thereby generating the parsing result.

12. The apparatus of claim 11, wherein the information that is needed to determine the hacking attempt includes at least one of an accessing person, an accessed document, an access failure reason, and an access path.
